(19) United States
(12) Patent Application Publication
(10) Pub. No.: US 2026/0195527 A1
(43) Pub. Date: Jul. 9, 2026

(54) PDF INGESTION USING INFERRED HIERARCHY FOR QUESTION ANSWERING MODEL

(71) Applicant: International Business Machines Corporation, Armonk, NY (US)

(72) Inventors: Radha Mohan De, Howrah (IN); Sujoy Roy, Kolkata (IN); SWARUP ROY, Kolkata (IN); SURAJIT SAHA, Kolkata (IN)

(21) Appl. No.: 19/010,720

(22) Filed: Jan. 6, 2025

(51) Int. Cl. G06F 40/205; G06F 40/109; G06F 40/137; G06F 40/258; G06F 40/30; G06F 40/40; G06V 30/10; G06V 30/40

(52) U.S. Cl. CPC G06F 40/205; G06F 40/109; G06F 40/137; G06F 40/258; G06F 40/30; G06F 40/40; G06V 30/10; G06V 30/40

(57) ABSTRACT

A system includes a processor that executes computer executable components stored in a memory. The computer executable components can include an extraction component that extracts elements from an unstructured document. The computer executable components can further include a mapping component that maps elements to structural roles. The computer executable components can further include an organizing component that uses the mapping to organize related content into distinct groups.

### TECHNICAL FIELD

The subject disclosure relates to efficient ingestion of unstructured documents, e.g., utilizing inferred hierarchies in unstructured documents to map elements to structural roles.

### BACKGROUND

Document-based question answering (DBQA) can enable artificial intelligence (AI) systems to provide natural answers to questions derived from specific documents. Quality of document-based question answering systems largely depends on ingestion process and ability of artificial intelligence or large language models (LLMs) to interpret and summarize content accurately. This challenge is pronounced with unstructured documents, such as PDFs, containing text, images, and tables. Current methods struggle with complex layouts and non-text elements, leading to poor question-answering outcomes.

Existing approaches face limitations, including difficulty processing complex document formats, privacy risks from proprietary models, incomplete understanding of domain-specific jargon, and inefficiencies in large-scale PDF processing. These challenges often require significant human oversight. Despite advancements, no method effectively extracts and understands diverse PDF content for high-quality document-based question answering.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate efficient ingestion of unstructured documents.

According to an embodiment, a system can comprise a processor that executes computer executable components stored in memory. The computer executable components can comprise an extraction component that extracts elements from an unstructured document. The computer executable components can further comprise a mapping component that maps elements to structural roles. The computer executable components can further comprise an organizing component that uses the mapping to organize related content into distinct groups.

According to another embodiment, a computer-implemented method can comprise extracting, by a system operatively coupled to a processor, elements from an unstructured document. The computer-implemented method further comprises mapping, by a system, elements to structural roles. The computer implemented method can further comprise organizing, by the system, related content into distinct groups.

According to another embodiment, a computer program product comprising a computer readable storage medium having program instructions embodied therewith, the program instructions executable by a processor to cause the processor to extract, by the processor, elements from an unstructured document. The program instructions can also cause the processor to map, by the processor, elements to structural roles. The program instructions can also cause the processor to organize, by the processor, related content into distinct groups.

### BRIEF DESCRIPTION OF THE DRAWINGS

FIGS. 1 and 2 illustrate example systems that can facilitate efficient ingestion of unstructured documents in accordance with some embodiments described herein.

FIGS. 3 and 4 illustrate flow diagrams of example computer implemented methods that can efficient ingestion of unstructured documents in accordance with some embodiments described herein.

FIG. 5 illustrates an example flow diagram that can facilitate efficient ingestion of unstructured files in accordance with some of the embodiments described herein.

FIG. 6 illustrates an example font distribute table in accordance with some embodiments described herein.

FIG. 7 illustrates an example illustration of unstructured document chunking method in accordance with some of the embodiments described herein.

FIG. 8 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Document-based question answering is a significant capability of generative artificial intelligence, enabling systems to create accurate, natural-language responses to questions derived from specific documents. This capability has far-reaching applications where extracting nuanced insights from extensive documentation is essential. Performance of document-based question answering systems depends heavily on quality of ingestion process. Document ingestion process can include breaking down documents into smaller, meaningful chunks for analysis. After processing, an artificial intelligence or large language model can utilize chunks to generate relevant and accurate answers.

Challenges become particularly evident with unstructured documents, such as PDF documents, which often feature a complex combination of text, tables, images, or other elements. Unlike structured text formats, unstructured documents can include content organized in non-linear layouts, making it difficult for conventional artificial intelligence systems to understand semantic and contextual relationships between elements. Inability to process hybrid content effectively can result in incomplete or irrelevant answers.

Current methods for processing unstructured documents encounter several critical limitations, which collectively hinder effectiveness. Tools like Optical Character Recognition (OCR), template-based approaches using Regular Expressions (Regex), machine learning, or large language models often fail to understand semantic and ontological relationships among contents with different types of presentations. Methods can struggle to handle intricate formatting or non-textual elements, such as images, charts, or tables, which are integral to the meaning of many documents. Additionally, current solutions can rely on proprietary artificial intelligence models which can introduce privacy concerns. Current methods can be additionally constrained by general-purpose design, leading to an incomplete understanding of domain-specific jargon or highly specialized content. Inefficiency of existing systems in handling large-scale document processing remains a major bottleneck. Human intervention is often required to correct errors or fill in gaps, which can slow down operations. These combined challenges underscore the inadequacy of current technologies in extracting, interpreting, or utilizing diverse content types present in unstructured documents, thereby reducing overall quality of document-based question answering.

To address these challenges, using inferred hierarchies for ingestion of unstructured documents can greatly improve capabilities of document-based question answering systems.

Innovations disclosed herein can improve the ability of artificial intelligence systems to accurately parse, interpret, or analyze complex unstructured documents, such as PDF documents.

In relation to efficient ingestion of unstructured documents, embodiments disclosed herein produce a solution to one or more of these problems. These embodiments can solve such problems by extracting elements from an unstructured document; by mapping elements to structural roles; by organizing related content into distinct groups.

According to an embodiment, a system can include a processor that executes computer executable components stored in a memory. The computer executable components can include an extraction component that extracts elements from an unstructured document. The computer executable components can further include a mapping component that maps elements to structural roles. The computer executable components can further include an organizing component that uses the mapping to organize related content into distinct groups.

In some embodiments, the system can further comprise an artificial intelligence component that can train an artificial intelligence model on mapped elements to respective structural roles, enabling enhanced accuracy and efficiency in understanding and processing complex document structures. In other embodiments, the artificial intelligence component can train an artificial intelligence model to assign contextual tags to grouped elements based on semantic content and structural role.

In some embodiments, the system can further comprise an output component that prepares large language model (LLM) word embeddings from organized distinct groups. In some embodiments, the output component can use prepared LLM word embeddings to execute a language model query.

In some embodiments, extraction component can parse content from a PDF document format. According to some embodiments, the extraction component can further use optical character recognition or OpenCV libraries to decipher text within images. In other embodiments, the extraction component can use spatial data from tables within the document to infer logical relationship of a subset of the elements.

According to some embodiments, the mapping component can use font information comprising size, style, or distribution to determine structural role of a text element. In some embodiments, the mapping component can assign document elements to structural categories comprising title, body, or footer as a function of structural indicators.

In other embodiments, the organizing component can infer logical coherence among grouped elements by analyzing font consistency or spatial arrangement across sections.

Advantages of this system may include improved accuracy in parsing complex unstructured documents, reduced dependency on expensive proprietary models, or enhanced scalability for processing large volumes of diverse content.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

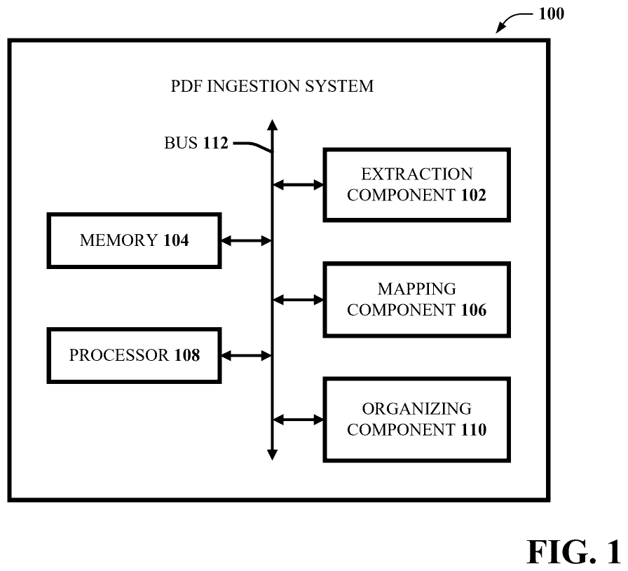

FIG. 1 illustrates an example system 100 for facilitating efficient ingestion of unstructured documents. System 100 uses an extraction component, mapping component, and an organizing component. The extraction component can extract elements from an unstructured document. The mapping component can map elements to structural roles. The organizing component can use the mapping to organize related content into distinct groups.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise an extraction component 102, a memory 104, a mapping component 106, a processor 108, an organizing component 110, and a system bus 112.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to ingestion of unstructured documents by improving the accuracy of parsing complex unstructured documents, reduced dependency on expensive proprietary models, or enhanced scalability for processing large volumes of diverse content.

System 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the extraction component 102, the mapping component 106, and/or the organizing component 110) to perform one or more actions. In some embodiments, the memory 104 can store computer-executable components (e.g., the extraction component 102, the mapping component 106, and/or the organizing component 110).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the extraction component 102 extracts elements from an unstructured document. In some embodiments, the extraction component 102 can parse content from a PDF document format. According to other embodiments, the extraction component 102 can further use optical character recognition or OpenCV libraries to decipher text within images. In some embodiments, the extraction component 102 can use spatial data from tables within the document to infer logical relationship of a subset of the elements.

According to some embodiments, the mapping component 106 maps elements to structural roles. In some embodiments, the mapping component 106 can use font information comprising size, style, or distribution to determine structural role of a text element. In other embodiments, the mapping component 106 can assign document elements to structural categories comprising title, body, or footer as a function of structural indicators.

In various embodiments, the organizing component 110 can use the mapping to organize related content into distinct groups. In other embodiments, the organizing component 110 can infer logical coherence among grouped elements by analyzing font consistency or spatial arrangement across sections.

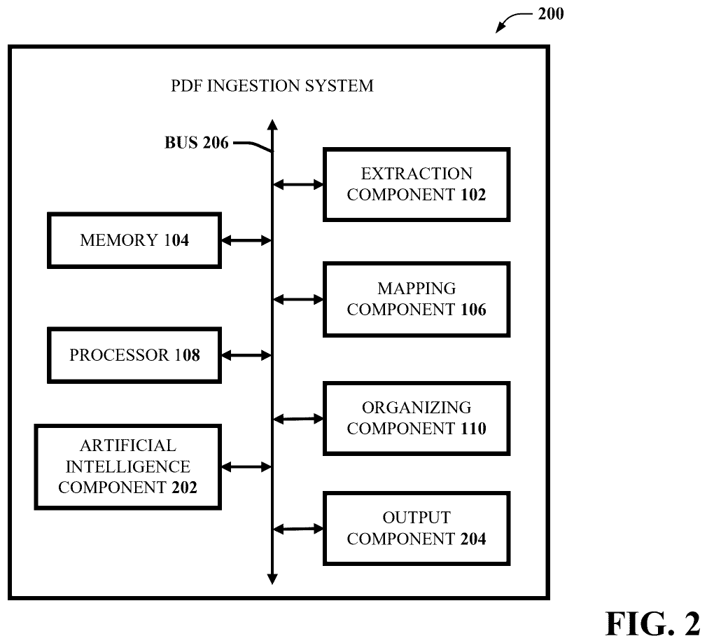

FIG. 2 illustrates an example system 200 that can facilitate efficient ingestion of unstructured documents. System 200 uses extraction component 102, mapping component 106, organizing component 110, artificial intelligence component 202, and output component 204. The extraction component 102 extracts elements from an unstructured document. The mapping component 106 maps elements to structural roles. The organizing component 110 uses the mapping to organize related content into distinct groups. Description of like components has been omitted for the sake of brevity.

In various embodiments, artificial intelligence component 202 trains an artificial intelligence model on mapped elements to respective structural roles. In other embodiments, artificial intelligence component 202 trains an artificial intelligence model to assign contextual tags to grouped elements based on semantic content and structural role.

In various embodiments, output component 204 prepares large language model (LLM) word embeddings from organized distinct groups. In other embodiments, output component 204 can further use prepared LLM word embeddings to execute a language model query.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

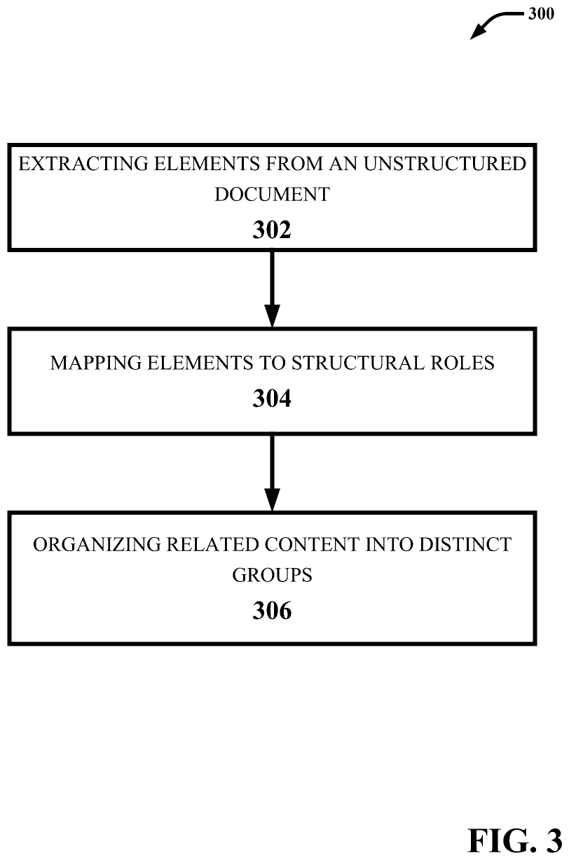

Next, FIG. 3 illustrates a flow diagram of a method 300 that can facilitate efficient ingestion of unstructured documents in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 extracts elements from an unstructured document. The method 300 can use a system operatively coupled to a processor (e.g., extraction component 102) to extract elements from an unstructured document. Elements can include, but are not limited to, text, images, and tables.

At 304, method 300 includes mapping elements to structural roles. The method 300 can use a system operatively coupled to the processor (e.g., mapping component 106) to map elements to structural roles. Structural roles can include, but are not limited to, header, title, body, and footnotes.

At 306, method 300 includes organizing related content into distinct groups. The method 300 can use a system operatively coupled to the processor (e.g., organizing component 110) to organize related content into distinct groups.

In some embodiments, method 300 is performed by a system, such as system 100 of FIG. 1 or system 200 of FIG. 2. Extracting elements from an unstructured document 302 can be performed by an extraction component (e.g., extraction component 102 of FIG. 2). Mapping elements to structural roles 304 can be performed by a mapping component (e.g., mapping component 106). Organizing related content into distinct groups 306 can be performed by a mapping component (e.g., mapping component 106).

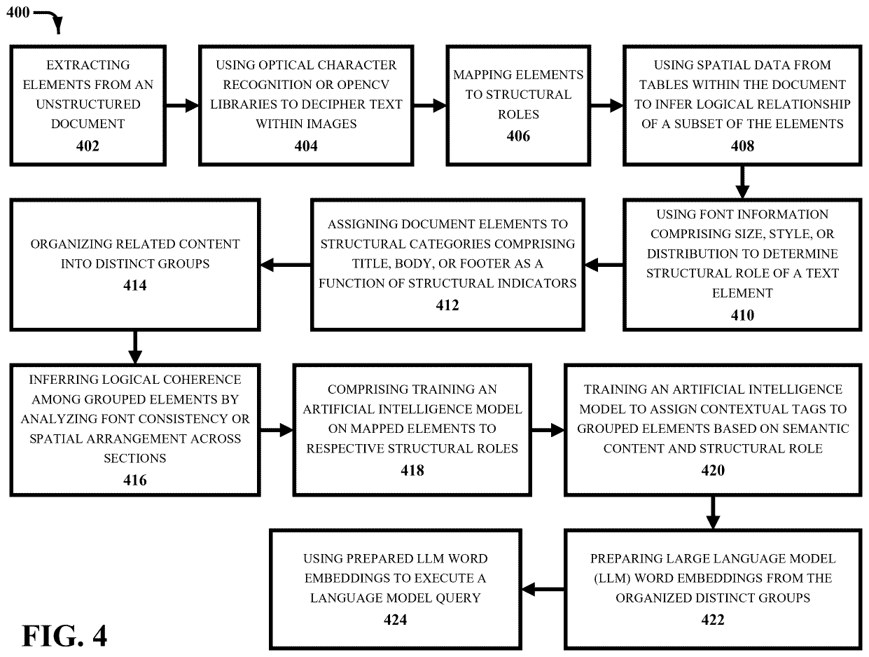

Next, FIG. 4 illustrates a flow diagram of a method 400 that can facilitate efficient ingestion of unstructured documents in accordance with some embodiments described herein. While the method 400 is described relative to the system 200 of FIG. 2, the method 400 can be applicable also to other systems described herein, such as the system 100 of FIG. 1.

At 402, the method 400 includes extracting elements from an unstructured document. The method 400 can use a system operatively coupled to the processor (e.g., extraction component 102) to extract elements from an unstructured document. In some embodiments, the system can parse content from a PDF document.

At 404, method 400 includes using optical character recognition or OpenCV libraries to decipher text within images. The method 400 can use a system operatively coupled to the processor (e.g., extraction component 102) to decipher text within images.

At 406, method 400 includes mapping elements to structural roles. The method 400 can use a system operatively coupled to the processor (e.g., mapping component 106) to map elements to structural roles.

At 408, method 400 includes using spatial data from tables within the document to infer logical relationship of a subset of the elements. The method 400 can use a system operatively coupled to the processor (e.g., mapping component 106) to use spatial data from tables within the document to infer logical relationship of a subset of the elements.

At 410, method 400 includes using font information comprising size, style, or distribution to determine structural role of a text element. The method 400 can use a system operatively coupled to the processor (e.g., mapping component 106) to use font information comprising size, style, or distribution to determine structural role of a text element.

At 412, method 400 includes assigning document elements to structural categories comprising title, body, or footer as a function of structural indicators. The method 400 can use a system operatively coupled to the processor (e.g., mapping component 106) to assign document elements to structural categories comprising title, body, or footer as a function of structural indicators.

At 414, method 400 includes organizing related content into distinct groups. The method 400 can use a system operatively coupled to the processor (e.g., organizing component 110) to organize related content into distinct groups.

At 416, method 400 includes inferring logical coherence among grouped elements by analyzing font consistency or spatial arrangement across sections. The method 400 can use a system operatively coupled to the processor (e.g., organizing component 110) to infer logical coherence among grouped elements by analyzing font consistency or spatial arrangement across sections.

At 418, method training an artificial intelligence model on mapped elements to respective structural roles. The method 400 can use a system operatively coupled to the processor (e.g., artificial intelligence component 202) to train an artificial intelligence model on mapped elements to respective structural roles.

At 420, the method 400 includes training an artificial intelligence model to assign contextual tags to grouped elements based on semantic content and structural role. The method 400 can use a system operatively coupled to the processor (e.g., artificial intelligence component 202) to train an artificial intelligence model to assign contextual tags to grouped elements based on semantic content and structural role.

At 422, the method 400 includes preparing large language model (LLM) word embeddings from the organized distinct groups. The method 400 can use a system operatively coupled to the processor (e.g., output component 204) to prepare large language model (LLM) word embeddings from the organized distinct groups.

At 424, method 400 includes using the prepared LLM word embeddings to execute a language model query. The method 400 can use a system operatively coupled to the processor (e.g., output component 204) to use the prepared LLM word embeddings to execute a language model query.

One or more systems, devices, computer program products, and/or computer-implemented methods provided herein relate to efficient ingestion of unstructured documents. A system can include a processor that executes computer executable components stored in memory. The computer executable components can include an extraction component that extracts elements from an unstructured document. The computer executable components can further include a mapping component that maps elements to structural roles. The computer executable components can further include an organizing component that uses the mapping to organize related content into distinct groups.

Advantages of a system can include improved accuracy in parsing complex unstructured documents, reduced dependency on expensive proprietary models, or enhanced scalability for processing large volumes of diverse content.

In various embodiments, the extraction component 102 extracts elements from an unstructured document. In some embodiments, the extraction component 102 can parse content from a PDF document format. According to some embodiments, the extraction component 102 can further use optical character recognition or OpenCV libraries to decipher text within images. In other embodiments, the extraction component 102 can use spatial data from tables within the document to infer logical relationship of a subset of the elements.

According to some embodiments, the mapping component 106 maps elements to structural roles. In some embodiments, the mapping component 106 can use font information comprising size, style, or distribution to determine structural role of a text element. In some embodiments, the mapping component 106 can assign document elements to structural categories comprising title, body, or footer as a function of structural indicators.

In various embodiments, the organizing component 110 can use the mapping to organize related content into distinct groups. In other embodiments, the organizing component 110 can infer logical coherence among grouped elements by analyzing font consistency or spatial arrangement across sections.

In various embodiments, artificial intelligence component 202 trains an artificial intelligence model on mapped elements to respective structural roles. In other embodiments, artificial intelligence component 202 trains an artificial intelligence model to assign contextual tags to grouped elements based on semantic content and structural role.

In various embodiments, output component 204 prepares large language model (LLM) word embeddings from the organized distinct groups. In other embodiments, output component 204 can further use prepared LLM word embeddings to execute a language model query.

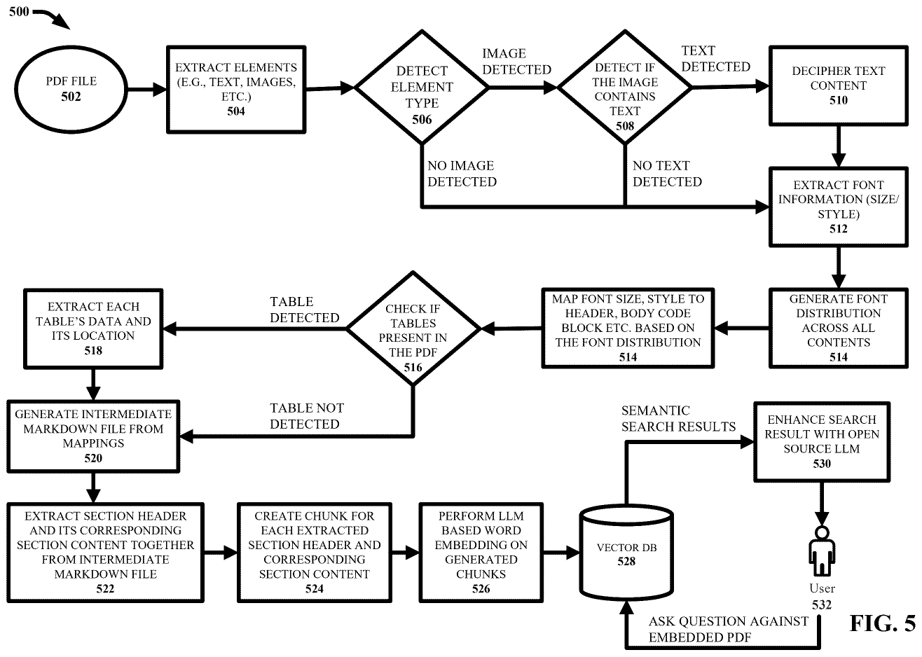

FIG. 5 illustrates an example flow diagram that can facilitate efficient ingestion of unstructured files in accordance with some of the embodiments described herein. At 502, a system can receive a PDF file. In some embodiments, a system can receive a natural language query in addition to an unstructured file, such as a PDF. In various embodiments, a system can receive a different type of unstructured file. A file received can include multiple pages of content. At 504, a system can extract elements from a file, such as text or images. In various embodiments, a system can use a standard PDF mining tool to extract information, such as images or text.

When an element is extracted from a file, a system can detect an element type 506. If a system detects that an element type extracted from a file is not an image, a system can proceed to 512 to extract font information from a file, including details such as size and style. If a system detects that an element type extracted from a file is an image, a system can proceed to determine whether an image contains text 508. In various embodiments, a system can use optical character recognition or OpenCV libraries to detect text within images. If a system determines that there is not text detected within an image, a system can proceed to 512 to extract font information from a file, including details such as size or style. If a system determines that there is text detected within an image, a system can proceed to 510 where a system can decipher text content. In various embodiments, a system can use optical character recognition or OpenCV libraries to decipher text within images.

After detected text within an image is deciphered in 510, a system can proceed to 512 where font information can be extracted. Font information can include style and size.

At 514, a system can generate a font distribution across all contents. In some embodiments, a system can populate a CSV file to depict font distribution pattern in an unstructured file. A system can utilize the following method to plot distribution for creating a mapping for different parts of content against font styles.

$$Font Size = N \& Font Style = C \& Distribution = Maximum \to Body Content \qquad ( 1 )$$

$$Font Size < N \& Font Style = C \& Distribution = Moderate \to Body Content or Foot Notes or Section Notes \qquad ( 2 )$$

$$Font Size > N \& Font Style ( Stronger ) > C \& Distribution = Less \to Section Header or Title \qquad ( 3 )$$

In the equations above, a system can classify font size as normal (“N”), large, or small. Additionally, the system can utilize font style, denoted as “C” (common), to determine text classification. A font style of “C” (common) can indicate body content, while a stronger “C” (common) can denote a header or title. Font size and style information can be plotted, enabling analysis and determination of distribution.

If font size is normal, font style is common, and distribution is maximum, then a section can be determined to be body content (1). If font size is smaller than normal, font style is common, and distribution is moderate, then a section can be determined to be either body content, foot notes, or section notes (2). If font size is larger than normal, font style is stronger than common style, and distribution is low, then the section can be determined to be a header or title (3).

At 514, a system can use font information, such as size or style, and font distribution to map elements to structural roles, including but not limited to headers, title, body content, or footnotes.

At 516, a system can check whether tables are present in an unstructured file. If a system determines that no tables are present in an unstructured file, a system can proceed to 520 where an intermediate markdown file can be generated from mappings. If a system determines that tables are present in an unstructured file, a system can extract each table's data and location. In some embodiments, a system can retrieve data contained within each table as well as its structural layout, such as rows, columns, or cell relationships. According to some embodiments, a system can determine an exact location of each table within an unstructured document, which can be critical for preserving context.

After content from tables within a file are successfully extracted, at 520 a system can generate an intermediate markdown file from mappings in 514. Intermediate markdown file can use tags for headers, body, or other structural roles. Each tag corresponding to a structural role within a file can include all content associated with structural role.

In 522, a system can extract content corresponding to each structural role from intermediate markdown file. Content for each structural role can be chunked together in 524. At 526, a system can perform a large language model-based word embedding on generated chunks from 524. By generating word embeddings, a system can help assist in semantic search of an unstructured file.

Word embeddings can be stored in a vector database 528. Vector database 528 can be used to enhance search results with an open-source large language model 530. In some embodiments, a user 532 of a system can ask natural language questions against embedded unstructured file.

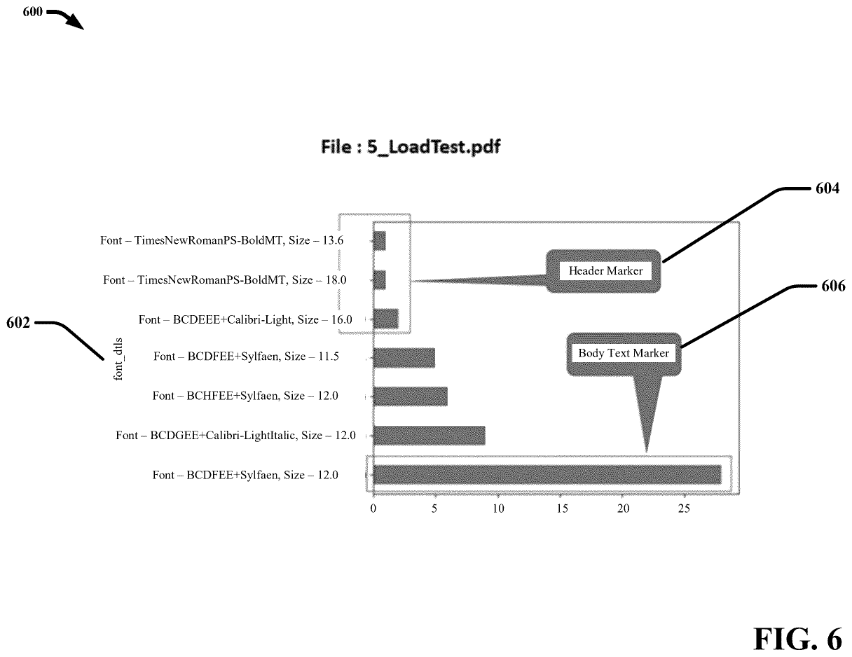

FIG. 6 illustrates an example font distribute table in accordance with some embodiments described herein. Example table 600 illustrates a font distribution table for an example PDF document titled “5_LoadTest.PDF.” Font distribution table can be calculated using font details, such as size or style. In some embodiments, a system can populate a CSV file to depict font distribution pattern in an unstructured file.

Different font sizes and styles may be represented along the x-axis 602. Frequency amounts can be represented numerically along the y-axis. Distributions of font size and style combinations identified within a PDF document may be depicted as horizontal bars. Smaller horizontal bars can indicate that a font size and style combination does not appear frequently within a document. Larger horizontal bars can indicate that a font size and style combination appear frequently within a document.

Once font distributions are plotted, a system may determine frequency of each font size and style combination in relation to entirety of a document. A system can utilize the following method to create a mapping for different parts of content against font styles.

$$Font Size = N \& Font Style = C \& Distribution = Maximum \to Body Content \qquad ( 1 )$$

$$Font Size < N \& Font Style = C \& Distribution = Moderate \to Body Content or Foot Notes or Section Notes \qquad ( 2 )$$

$$Font Size > N \& Font Style ( Stronger ) > C \& Distribution = Less \to Section Header or Title \qquad ( 3 )$$

In the equations above, a system can classify font size as normal (“N”), large, or small. Additionally, the system can utilize font style, denoted as “C” (common), to determine text classification. A font style of “C” (common) can indicate body content, while a stronger “C” (common) can denote a header or title. Font size and style information can be plotted, enabling analysis and determination of distribution.

If font size is normal, font style is common, and distribution is maximum, then a section is determined to be body content (1). If font size is smaller than normal, font style is common, and distribution is moderate, then a section can be determined to be either body content, foot notes, or section notes (2). If font size is larger than normal, font style is stronger than common, and distribution is low, then a section can be determined to be a header or title (3).

Font size, style, and distribution combinations can identify text types. Combination 604 can be determined as a header due to uncommon style, small size, and low distribution. Combination 606 can be identified as body content due to common style, normal size, and high distribution.

Once a system maps font size, style, and distribution combination to the appropriate structural role, a system can use markers to keep track of contents corresponding structural role stored in an intermediate markup file.

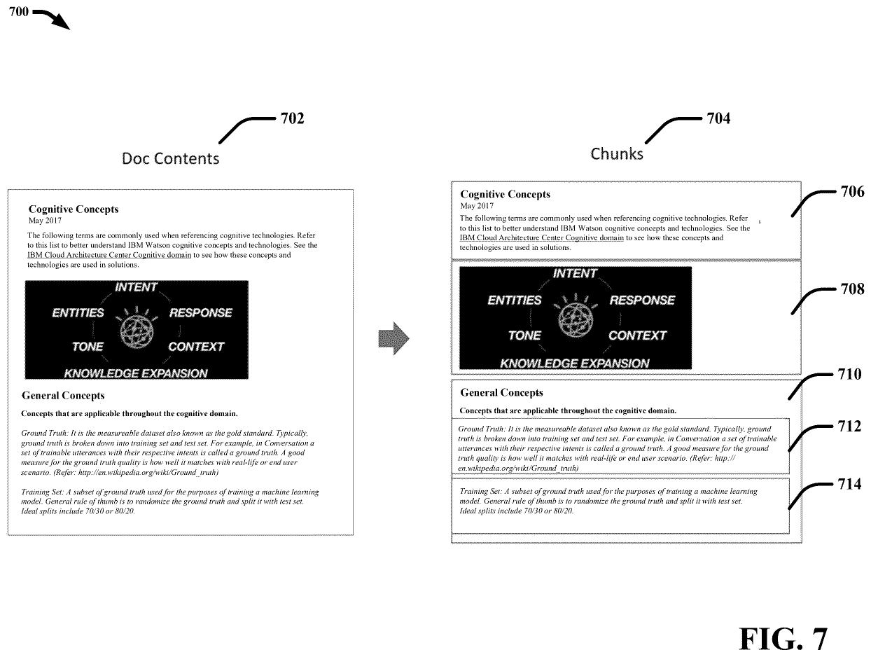

FIG. 7 illustrates an example illustration of the unstructured document chunking method in accordance with some of the embodiments described herein. At 702, an example of an original unstructured document content is displayed. The original document example contains multiple sections including images and text with various font sizes and styles. At 704, a document is displayed post-processing, where structural sections have been segmented into distinct chunks.

At 706, a section is identified as distinct based on the presence of enlarged, bold text followed by a block of standard-sized text, which the system can determine to correspond to the document's introduction.

At 708, a section can be designated as a unique chunk corresponding to an image. In various embodiments, a system can decipher text within the image.

At 710, text characterized by bold or large formatting can be identified as a header chunk. The header is further associated with corresponding body content sections, identified at steps 712 and 714, that logically follow the header.

At 712, a block of text with normal size and a distinct italicized style can be identified as a body content section, representing a cohesive part of the document.

At 714, a block of text with normal size and a distinct italicized style can be determined to constitute a distinct paragraph, forming a specific subsection of the body content.

The document broken down into various chunks corresponding to appropriate structural roles can be utilized by a large language model to perform word embeddings on generated chunks.

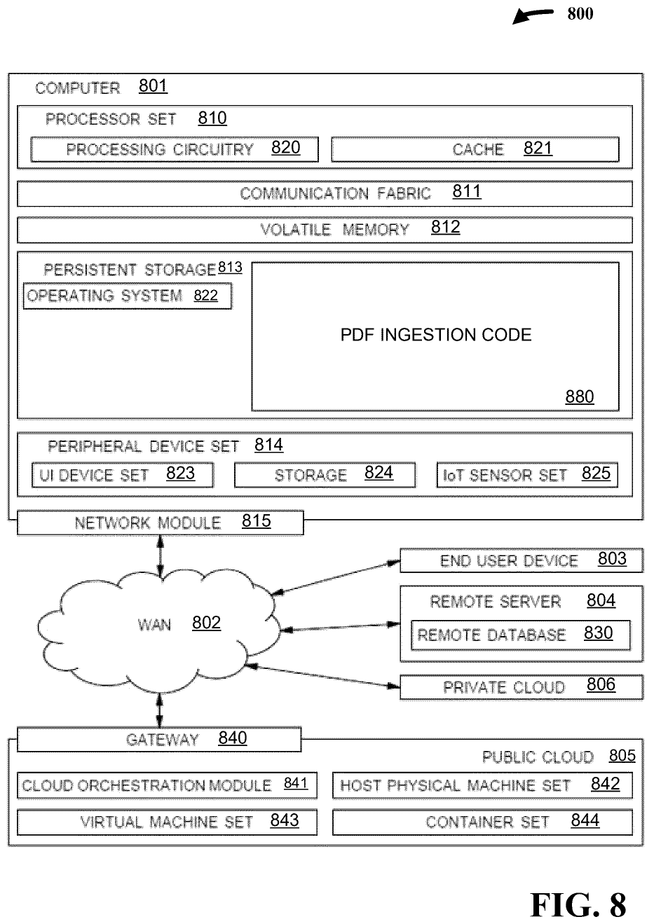

FIG. 8 and the following discussion are intended to provide a brief, general description of a suitable computing environment 800 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as extracting elements from an unstructured document with PDF ingestion code 880. In addition to block 880, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method can be distributed among multiple computers and/or between multiple locations. On the other hand, in this presentation of computing environment 800, detailed discussion is focused on a single computer, specifically computer 801, to keep the presentation as simple as possible. Computer 801 can be located in a cloud, even though it is not shown in a cloud in FIG. 8. On the other hand, computer 801 is not required to be in a cloud except to any extent as can be affirmatively indicated.

PROCESSOR SET 810 includes one, or more, computer processors of any type now known or to be developed in the future. Processing circuitry 820 can be distributed over multiple packages, for example, multiple, coordinated integrated circuit chips. Processing circuitry 820 can implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set can be located “off chip.” In some computing environments, processor set 810 can be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods can be stored in block 845 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory can be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 can be a read only memory (ROM), but typically at least a portion of the persistent storage allows writing of data, deletion of data and re-writing of data. Some familiar forms of persistent storage include magnetic disks and solid-state storage devices. Operating system 822 can take several forms, such as various known proprietary operating systems or open-source Portable Operating System Interface type operating systems that employ a kernel. The code included in block 845 typically includes at least some of the computer code involved in performing the inventive methods.

PERIPHERAL DEVICE SET 814 includes the set of peripheral devices of computer 801. Data communication connections between the peripheral devices and the other components of computer 801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 can include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 can be persistent and/or volatile. In some embodiments, storage 824 can take the form of a quantum computing storage device for storing data in the form of qubits. In embodiments where computer 801 is required to have a large amount of storage (for example, where computer 801 locally stores and manages a large database) then this storage can be provided by peripheral storage devices designed for storing large amounts of data, such as a storage area network (SAN) that is shared by multiple, geographically distributed computers. IoT sensor set 825 is made up of sensors that can be used in Internet of Things applications. For example, one sensor can be a thermometer, and another sensor can be a motion detector.

NETWORK MODULE 815 is the collection of computer software, hardware, and firmware that allows computer 801 to communicate with other computers through WAN 802. Network module 815 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and can take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 can be a client device, such as thin client, heavy client, mainframe computer and/or desktop computer.

REMOTE SERVER 804 is any computer system that serves at least some data and/or functionality to computer 801. Remote server 804 can be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data can be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs can be stored as images and can be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware and firmware allowing public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
an extraction component that extracts elements from an unstructured document;
a mapping component that maps elements to structural roles; and
an organizing component that uses the mapping to organize related content into distinct groups.

2. The system of claim 1, wherein the extraction component is configured to parse content from a PDF document format.

3. The system of claim 1, wherein the extraction component uses optical character recognition or OpenCV libraries to decipher text within images.

4. The system of claim 1, wherein the extraction component uses spatial data from tables within the document to infer logical relationship of a subset of the elements.

5. The system of claim 1, wherein the mapping component uses font information comprising size, style, or distribution to determine structural role of a text element.

6. The system of claim 1, wherein the mapping component assigns document elements to structural categories comprising title, body, or footer as a function of structural indicators.

7. The system of claim 1, wherein the organizing component infers logical coherence among grouped elements by analyzing font consistency or spatial arrangement across sections.

8. The system of claim 1, further comprising an artificial intelligence component that trains an artificial intelligence model on mapped elements to respective structural roles.

9. The system of claim 1, wherein an artificial intelligence component trains an artificial intelligence model to assign contextual tags to grouped elements based on semantic content and structural role.

10. The system of claim 1, further comprising an output component that prepares large language model (LLM) word embeddings from the organized distinct groups.

11. The system of claim 10, wherein the output component further uses the prepared LLM word embeddings to execute a language model query.

12. A computer-implemented method that utilizes a processor that executes computer executable components stored in memory to perform the following acts:
extracting elements from an unstructured document;
mapping elements to structural roles; and
organizing related content into distinct groups.

13. The method of claim 12, further comprising using optical character recognition or OpenCV libraries to decipher text within images.

14. The method of claim 12, further comprising using spatial data from tables within the document to infer logical relationship of a subset of the elements.

15. The method of claim 12, further comprising using font information comprising size, style, or distribution to determine structural role of a text element.

16. The method of claim 12, further comprising assigning document elements to structural categories comprising title, body, or footer as a function of structural indicators.

17. The method of claim 12, further comprising inferring logical coherence among grouped elements by analyzing font consistency or spatial arrangement across sections.

18. The method of claim 12, further comprising training an artificial intelligence model on mapped elements to respective structural roles.

19. The method of claim 12, further comprising training an artificial intelligence model to assign contextual tags to grouped elements based on semantic content and structural role.

20. A computer program product comprising a computer readable storage medium having program instructions embodied therewith, the program instructions executable by a processor to cause the processor to:
extract elements from an unstructured document;
map elements to structural roles; and
organize related content into distinct groups.
